(19) United States
(12) Patent Application Publication
(10) Pub. No.: US 2015/0246497 A1
(43) Pub. Date: Sep. 3, 2015

(54) UNDERGROUND COMPACTION SYSTEM FOR DISPOSAL OF COMPOSITE ORGANIC AND RECYCLABLE WASTE USING STANDARD WASTE CONTAINERS

(71) Applicant: Georgios Papadopoulos, Aridea Pellas (GR)

(72) Inventor: Georgios Papadopoulos, Aridea Pellas (GR)

(21) Appl. No.: 14/428,996

(22) PCT Filed: Oct. 14, 2013
(86) PCT No.: PCT/GR2013/000049

§ 371 Date: Mar. 18, 2015

(30) Foreign Application Priority Data
Oct. 24, 2012 (GR) 20120100541

(51) Int. Cl. B30B 11/00

(52) U.S. Cl. CPC B30B 11/00

(57) ABSTRACT

The present invention, named waste gradual compaction system inside of waste containers used by the local government organization for composite, organic and recyclable waste disposal, consists of a unit with a waste gradual compaction system in the interior of the container (1), the container protection system that protects the container from forces due to gradual compaction (2) and the outer casing which is airtight and watertight (3). Advantage of this invention is that we have over ten times more waste in the same storing space, we have reduction in waste collection time, a reduction in garbage truck circulation and the continued use of the existing garbage truck equipment and waste containers used by the local government organization without need for any change.

The invention refers to the waste gradual compaction system in common waste containers used by the local government organization, for composite, organic and recyclable waste disposal, which consists of the unit with the gradual compaction system inside of the waste container, the container protection system which protects the container from forces due to the gradual compaction and the outer casing which is airtight and watertight.

In the global community the waste sector has created the need for waste collection from each house and neighborhood. Based on this fact a fleet of vehicles has been created as well as specific waste containers to serve this need. These containers are emptied and the contents loaded into a garbage truck, behind, in front or from the side of the vehicle. Until today these waste containers were placed in front of the buildings, at the edge of the blocks, in town squares etc.

Wherever these common waste containers are placed, in town squares, parks, detached houses, apartment buildings, factories, restaurants, public space, they are never in a convenient location and they have a poor outward appearance with foul odour attracting insects, animals and causing disease.

Additionally the common waste containers are filled quickly and are easily moved in case they are in the way of anyone passing, causing problems to the waste collectors and the citizens themselves. A large garbage truck fleet with large engines is on the streets every day, polluting the environment.

Today, new systems for the collection of composite, organic and recyclable waste have been created with all of their functions accessible by the user. The waste is piled in the containers through the main compartment of the gradual compaction system which is placed on the pavement at the waste container location point. With this simple and discrete system, common waste containers are disappeared as they are integrated inside the mechanism and thus multiplying the container capacity with the use of the gradual compaction system.

This system creates a combination of aesthetic and environmental protection. It is silent for the user and the surrounding space. Therefore it is ideal to be located in residential areas and in all waste collection points for use by adults, children, people with disabilities, etc.

Advantage of this invention is that the waste gradual compaction system in waste containers used by the local government organization is used as a means for prevention of atmospheric pollution and consequently climate change.

Advantage of this invention is the great benefit for the prevention of environmental pollution and climate change through the reduction by more than 80% in the circulation of large diesel powered garbage trucks and other vehicles, on a daily basis, which have a great negative impact on the environment.

Advantage of this invention is the economic benefit for the local government organization which is over 85%. The frequency of waste collection is greatly decreased, because the capacity of the system is much greater in the same containers. The waste in the container is compressed and thus the amount of waste stored is multiplied. Indicatively each system has the ability to store up to 10 m³ of compressed waste. Therefore the frequency of waste collection is substantially reduced.

Advantage of this invention is the reduced operating cost of waste collection due to the rapid and direct loading of the containers and the reduced volume of the waste, so that less manpower is needed leading to far fewer man-hours and lower cost for waste collection vehicles.

Advantage of this invention is that the system is able to process with the function of gradual compaction all types of waste, composite, paper, glass, metal, plastic becoming an effective and ideal solution for recycling that can be applied to all types of waste containers used by the local government organization.

Advantage of this invention is that each system of waste gradual compaction system is able to function as a complete set or as a separate compaction unit for organic, composite and recyclable waste.

Advantage of this invention is the improvement of cleanliness and hygiene in the area where the new system is installed, as it is sealed and closed, with the overground or underground installation of the gradual compaction system, problems due to weather conditions or external factors are avoided.

Advantage of this invention is the change and improvement of the aesthetic image of the area where the new waste containers are installed, as the conventional waste containers often present a poor appearance, because of long-term use or even vandalism.

Advantage of this invention is the great safety, because of its volume, the robust and airtight construction making moving or turning over by human intervention or natural phenomena such as air, storms and snow, difficult.

Advantage of this invention is that the equipment used by the local government organization, services or cleaning companies does not change as the same waste containers are used.

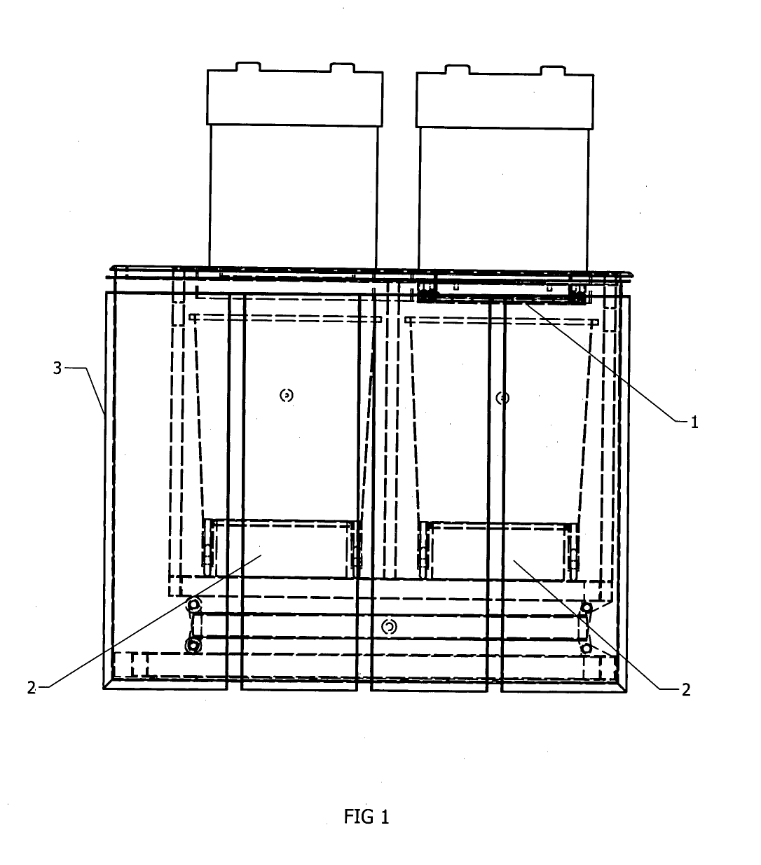

The present invention, named waste gradual compaction system inside of waste containers used by the local government organization for composite, organic and recyclable waste disposal, consists of a unit with a waste gradual compaction system in the interior of the container (1), the container protection system that protects the container from loads due to gradual compaction (2) and the outer casing which is airtight and watertight (3). The above are presented in general FIG. 1.

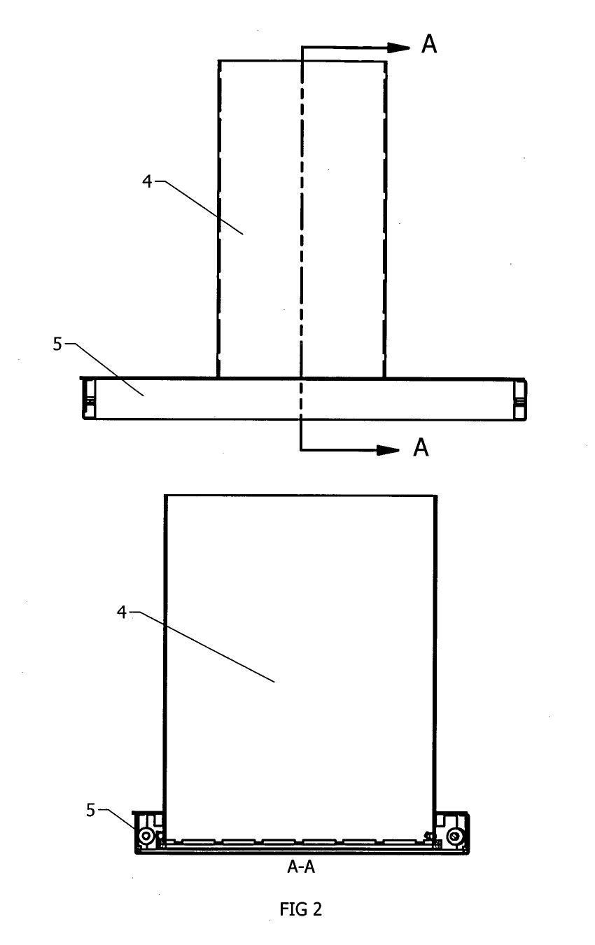

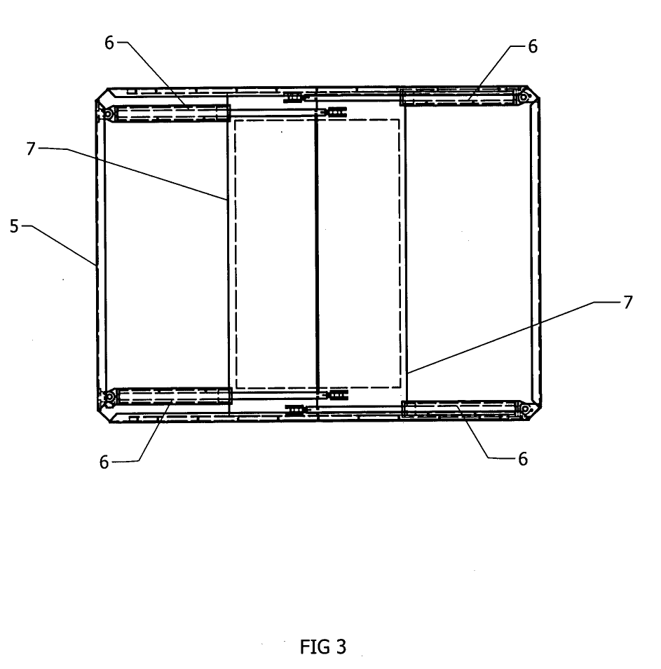

The waste gradual compaction system at the interior of the waste container is located on the upper part and at the center of the container, to ensure concentric garbage throwing, and consists of the space for throwing garbage through the center of the gradual compaction mechanism (4) as shown in FIG. 2, and the carrier for barring and compressing waste (5) which is located under the space for throwing garbage (4) and concentric with it which is operated by a hydrostatic pressure mechanism (6) located inside the barring and compressing carrier (5) and by applying pressure it opens the two barring and compressing guides (7) at the interior of the waste container. The above are shown in FIG. 3.

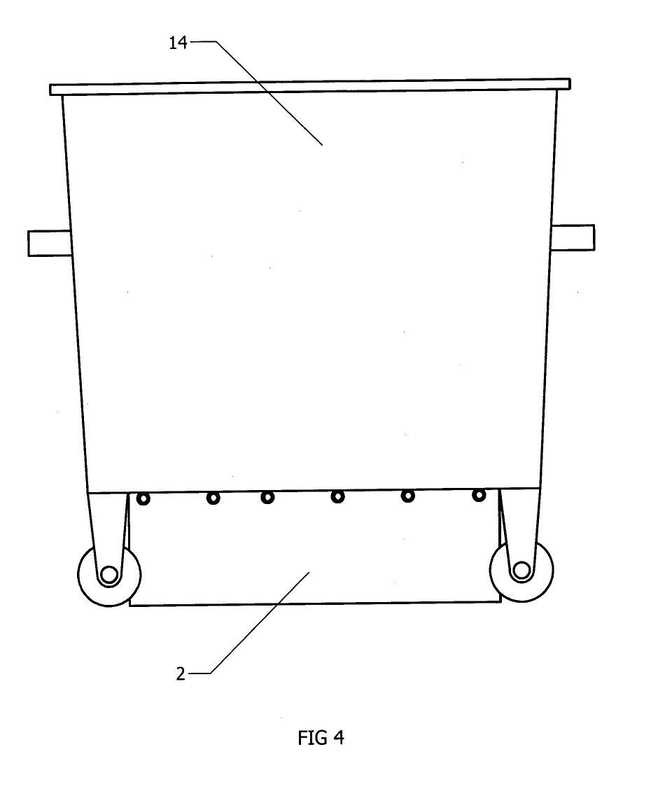

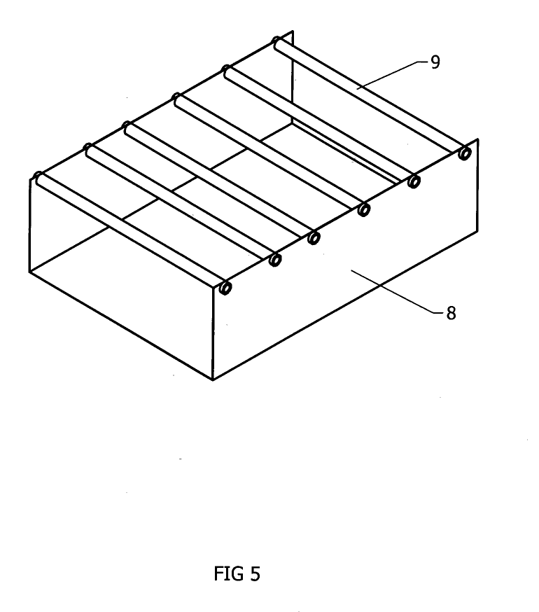

The container protection system which protects the container from the loads due to gradual compaction (2) shown in FIG. 4, is located just under the container (14) to provide the necessary protection from any deformation that may occur due to gradual compaction (4) shown in FIG. 2 and consists of a base of parallelepiped shape (8) with rolling shafts (9) shown in FIG. 5, which operate concentrically and are parallel to each other and to the floor of the container, thus accepting all the pressure of the waste gradual compaction device at the interior of the container at internal walls of the container (14) enhancing its robustness and protecting it from the forces applied on its floor, because of their rotating function and thus making the removal of the container easier.

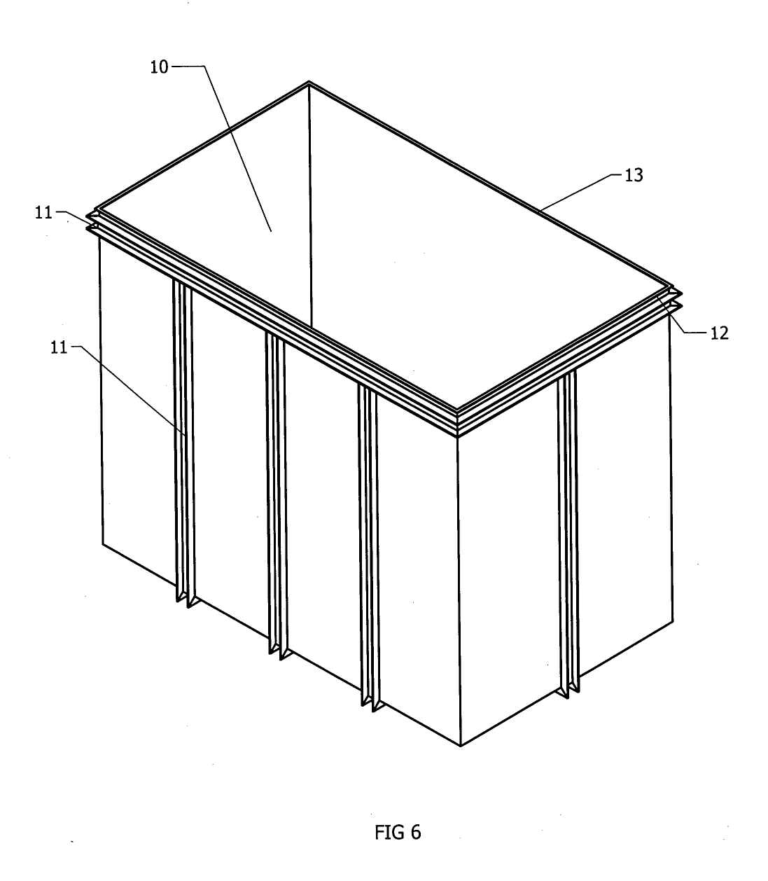

The outer casing which is airtight and watertight, closes the rest of the mechanism internally, protecting it in an airtight and watertight manner and it consists of an antioxidant metal container (10) with vertical and horizontal ribs on its outer surface (11) enhancing its strength. An iron blade (12) is located around the upper part of the container (10) creating a rim. On top of this a special gasket (13) is placed which comes in contact with the outer floor of the mechanism and seals the interior of the container (10) the whole mechanism and it protects it from external weather conditions. The above are shown in FIG. 6.

1. The waste gradual compaction system inside of waste containers used by the local government organization, for composite, organic and recyclable waste disposal, which consists of a unit with waste gradual compaction system at the interior of the waste container (1), the container protection system which protects the container from forces due to the gradual compaction (2) and the outer casing which is airtight and watertight (3).

2. The waste gradual compaction system inside of waste containers used by the local government organization for composite, organic and recyclable waste disposal, according to claim 1 is characterized by the waste gradual compaction device at the interior of the waste container (1), which is located on the upper part and at the center of the container, to ensure concentric garbage throwing, consists of the space for throwing garbage through the center of the gradual compaction mechanism (4) and the carrier for barring and compressing waste (5), which is located under and concentric to the space for throwing garbage (4) and is operated by a hydrostatic pressure mechanism (6), located inside the barring and compressing carrier (5) and by applying pressure it opens the two barring and compressing guides (7) at the interior of the waste container (14).

3. The waste gradual compaction system inside of waste containers used by the local government organization for composite, organic and recyclable waste disposal, according to claim 1 is characterized by the container protection system which protects the container from the forces due to gradual compaction (2), which is located just under the container (14), to provide the necessary protection from any deformation that may occur due to gradual compaction (4) and consists of a base of parallelepiped shape (8) with rolling shafts (9), which operate concentrically and are parallel to each other and to the floor of the container, thus accepting all the pressure of the waste gradual compaction device at the interior of the container, at the internal walls of the container (14) enhancing its robustness and protecting it from the forces applied on its floor because of their rotating function and thus making the removal of the container easier.

4. The waste gradual compaction system inside of waste containers used by the local government organization for composite, organic and recyclable waste disposal, according to claim 1 is characterized by the outer casing, which is airtight and watertight, which closes the rest of the mechanism internally, protecting it in an airtight and watertight manner and it consists of an antioxidant metal container (10) with vertical and horizontal ribs on its outer surface (11) enhancing its strength. An iron blade (12) is located around the upper part of the container (10) creating a rim. On top of this a special gasket (13) is placed which comes in contact with the outer floor of the mechanism and seals the interior of the container (10) the whole mechanism and it protects it from external weather conditions.
